(19) United States
(12) Patent Application Publication
(10) Pub. No.: US 2011/0029723 A1
(43) Pub. Date: Feb. 3, 2011

(54) Non-Volatile Memory Based Computer Systems

(75) Inventors: Charles C. Lee, Cupertino, CA (US); David Q. Chow, San Jose, CA (US); Abraham Chih-Kang Ma, Fremont, CA (US); I-Kang Yu, Palo Alto, CA (US); Ming-Shiang Shen, Taipei Hsien (TW)

Correspondence Address: ROGER H. CHU, 19499 ERIC DRIVE, SARATOGA, CA, 95070, US

(73) Assignee: Super Talent Electronics, Inc., San Jose, CA (US)

(21) Appl. No.: 12/885,451

(22) Filed: Sep. 18, 2010

Related U.S. Application Data
(62) Division of application No. 11/932,941, filed on Oct. 31, 2007.
Application No. 11/932,941 is a continuation-in-part of application No. 11/624,667, filed on Jan. 18, 2007, now abandoned.

(51) Int. Cl. G06F 12/02; G06F 12/00

(52) U.S. Cl. 711/103; 711/E12.001; 711/E12.008

(57) ABSTRACT

Non-volatile memory based computer systems and methods are described. According to one aspect of the invention, at least one non-volatile memory module is coupled to a computer system as main storage. The non-volatile memory module is controlled by a northbridge controller configured to control the non-volatile memory as main memory. The page size of the at least one non-volatile memory module is configured to be the size of one of the cache lines associated with a microprocessor of the computer system. According to another aspect, at least one non-volatile memory module is coupled to a computer system as data read/write buffer of one or more hard disk drives. The non-volatile memory module is controlled by a southbridge controller configured to control the non-volatile memory as an input/out device. The page size of the at least one non-volatile memory module is configured in proportion to characteristics of the hard disk drives.

### CROSS-REFERENCE TO RELATED APPLICATIONS

This application is a continuation-in-part (CIP) of co-pending U.S. patent application Ser. No. 11/770,642, filed on Jun. 28, 2007, entitled “High Speed Controller for Phase Change Memory Peripheral Devices”, which is a CIP of a U.S. patent application Ser. No. 10/818,653, filed on Apr. 5, 2004, entitled “Flash Memory System with a High-Speed Flash Controller”, now U.S. Pat. No. 7,243,185 issued on Jul. 10, 2007.

This application is also a CIP of co-pending U.S. patent application Ser. No. 11/624,667 filed on Jan. 18, 2007, entitled “Electronic data Storage Medium with Fingerprint Verification Capability”, which is a divisional patent application of U.S. patent application Ser. No. 09/478,720 filed on Jan. 6, 2000, now U.S. Pat. No. 7,257,714 issued on Aug. 14, 2007, which has been petitioned to claim the benefit of CIP status of one of inventor's earlier U.S. patent application for “Integrated Circuit Card with Fingerprint Verification Capability”, Ser. No. 09/366,976, filed on Aug. 4, 1999, now issued as U.S. Pat. No. 6,547,130.

### FIELD OF THE INVENTION

The present invention relates to computers, and more particularly to non-volatile memory based computer system and methods thereof.

### BACKGROUND OF THE INVENTION

Personal computers have become mainstream computing devices for the past two decades. One of the core components of a personal computer whether desktop or laptop is a mother board, which is the central or primary circuit board providing attachment points for one or more of the following: processor (CPU), graphics card, sound card, hard disk drive controller, memory (Random Access Memory (RAM)), and other external devices. All of the basic circuitry and components required for a personal computer to function are onboard the motherboard or are connected with a cable. The most important component on a motherboard is the chipset known as memory control hub (MCH) and input/output (I/O) control hub (ICH). MCH (also known as northbridge) typically handles communications between CPU, RAM, Accelerated Graphics Port (AGP) or Peripheral Component Interconnect Express (PCI-E), and ICH (also known as southbridge). ICH controls real time clock, Universal-Serial-Bus (USB), Advance Power Management (APM) and other devices.

FIG. 1A shows a prior art computer 140, which includes a mother board 132 with dynamic RAM (DRAM) 134 mounted thereon. DRAM 134 is controlled by memory controller unit 136. An I/O interface 138 is configured to facilitate communication between the mother board 132 and the host computer 140. DRAM 134 is configured as the main memory of the computer 132.

FIG. 1B shows another prior art computer 170, which includes a processor 160, a DRAM controller 156 (e.g., northbridge) and an I/O controller 154 (e.g., southbridge). The processor 160 includes a L1 cache 161 and a L2 cache 162. One or more DRAM modules 150 are coupled to the DRAM controller 156. One or more hard disk drives (HDD) 152 are coupled to the I/O controller 154. The DRAM controller 156 and the I/O controller 154 are coupled to a PCI-E 155. The DRAM modules may comprise single in-line memory module (SIMM) or dual in-line memory module (DIMM). Main memory of the computer 170 is provided by the DRAM module 150, while secondary storage is provided by the HDD 152.

Devices made of non-volatile memory such as flash memory have become very popular to replace secondary storage such as floppy, CD-ROM, etc. However, the non-volatile memory has not been applied to many other components of the computer. Therefore it would be desirable to have a computer using alternative rather than volatile memory as main and secondary storages.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Non-volatile memory based computer systems and methods are disclosed. According to one aspect of the present invention, at least one non-volatile memory module (e.g., flash memory, phase-change memory) is coupled to a computer system as main storage (i.e., main memory). The at least one non-volatile memory module is controlled by a northbridge controller configured to control the non-volatile memory as main memory. The page size of the at least one non-volatile memory module is configured to be the size of one of the cache lines associated with a microprocessor of the computer system.

According to another aspect of the present invention, at least one non-volatile memory module is coupled to a computer system as data read/write buffer of one or more hard disk drives (i.e., secondary storage). The at least one non-volatile memory module is controlled by a southbridge controller configured to control the non-volatile memory as an input/out device. The page size of the at least one non-volatile memory module is configured in proportion to characteristics of the hard disk drives.

According to one exemplary embodiment of the present invention, a non-volatile memory based computer system includes at least the following: an internal communication bus; at least one input/output interface coupling to an input/output (I/O) controller via said internal communication bus; at least one microprocessor configured to include at least one cache memory, each of the at least one cache memory includes a plurality of cache lines; one or more non-volatile memory modules; and a non-volatile memory controller coupling to said at least one processor and said one or more non-volatile memory module via said internal communication bus, wherein said one or more non-volatile memory module is configured to be divided into at least two separate addressable areas and a reserved area, each of the separate addressable areas and the reserved area is partitioned into a plurality of blocks and the plurality of blocks is further partitioned into a plurality of pages, each of the pages comprises a size related to the cache lines' size.

According to another exemplary embodiment of the present invention, a non-volatile memory based computer system includes at least the following: an internal communication bus; at least one input/output interface coupling to an input/output (I/O) controller via said internal communication bus; at least one microprocessor configured to include at least one cache memory, each of the at least one cache memory includes a plurality of cache lines; a non-volatile memory controller coupling to said at least one processor and said I/O controller; at least one hard disk drives configured as secondary storage; and one or more non-volatile memory modules, coupled to the I/O controller, configured as a data transfer buffer to said at least one hard disk drives.

One of the objects, features, and advantages in the present invention is that the non-volatile memory based motherboard eliminates the need of hard disk drive and/or dynamic random access memory. Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1A is a block diagram showing a prior art computer;

FIG. 1B is a block diagram showing another prior art computer;

FIG. 2A is a block diagram showing salient components of a first exemplary computer system configured with one or more non-volatile memory modules in accordance with one embodiment of the present invention;

FIG. 2B is a block diagram showing some components of a second exemplary computer system configured with one or more non-volatile memory modules in accordance with one embodiment of the present invention;

FIGS. 3A-3C are diagrams showing exemplary data structures used in the non-volatile memory controller and the non-volatile memory module of FIG. 2A in accordance with one embodiment of the present invention;

FIG. 4 is a block diagram showing salient components of an exemplary non-volatile memory controller in accordance with one embodiment of the present invention;

FIGS. 5A-5D are flowcharts collectively illustrating an exemplary process of performing memory read/write request in the non-volatile memory controller of FIG. 4, according to an embodiment of the present invention;

FIG. 6 is a schematic diagram showing an example of writing data into a non-volatile memory module in accordance with one embodiment of the present invention;

FIGS. 7A-7F are schematic diagrams collectively showing exemplary parallel interleaved data transfer operations of a non-volatile memory based computer system, according to an embodiment of the present invention;

FIG. 8A is a simplified drawing illustrating a first exemplary non-volatile memory module according an embodiment of the present invention; and

FIG. 8B is a simplified drawing depicting a second exemplary non-volatile memory module according another embodiment of the present invention.

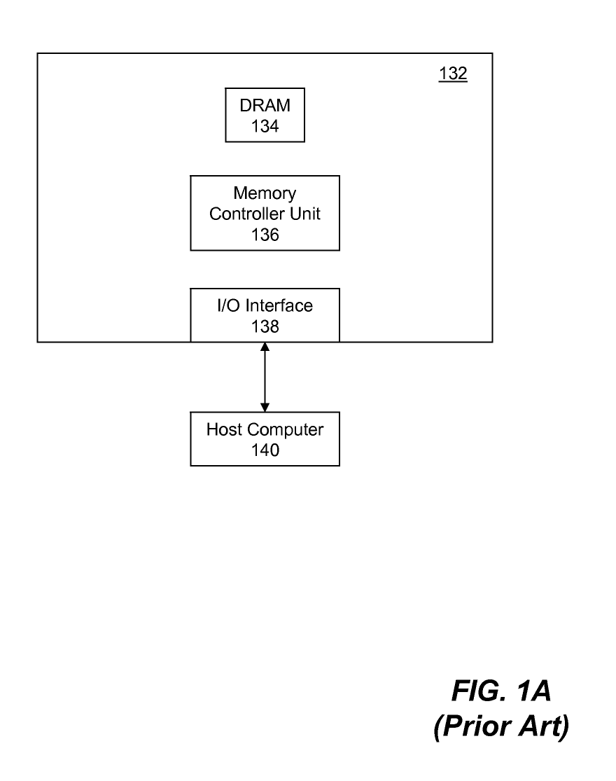

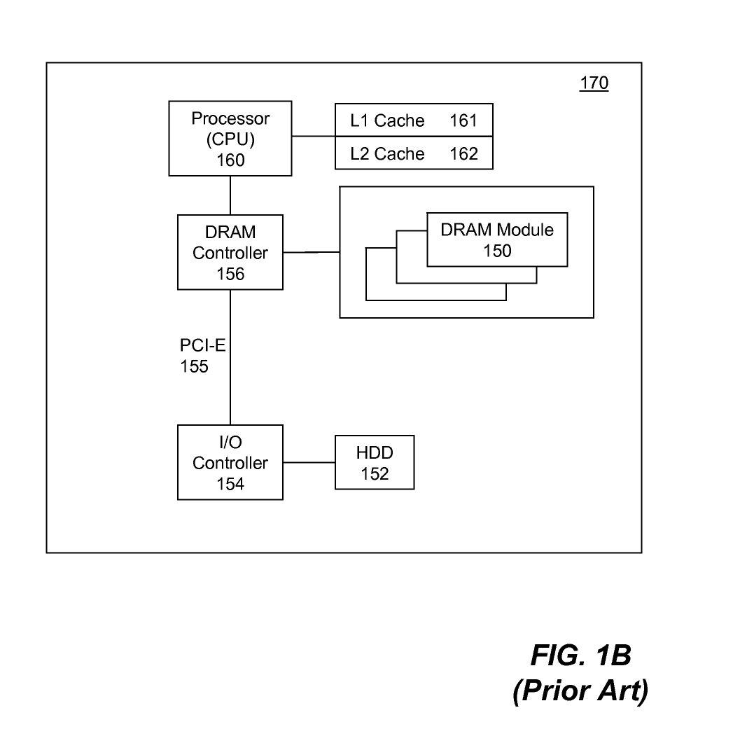

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Used herein, the terms “upper”, “lower”, “top”, “bottom”, “middle”, “upwards”, and “downwards” are intended to provide relative positions for the purposes of description, and are not intended to designate an absolute frame of reference. Further, the order of blocks in process flowcharts or diagrams representing one or more embodiments of the invention do not inherently indicate any particular order nor imply any limitations in the invention.

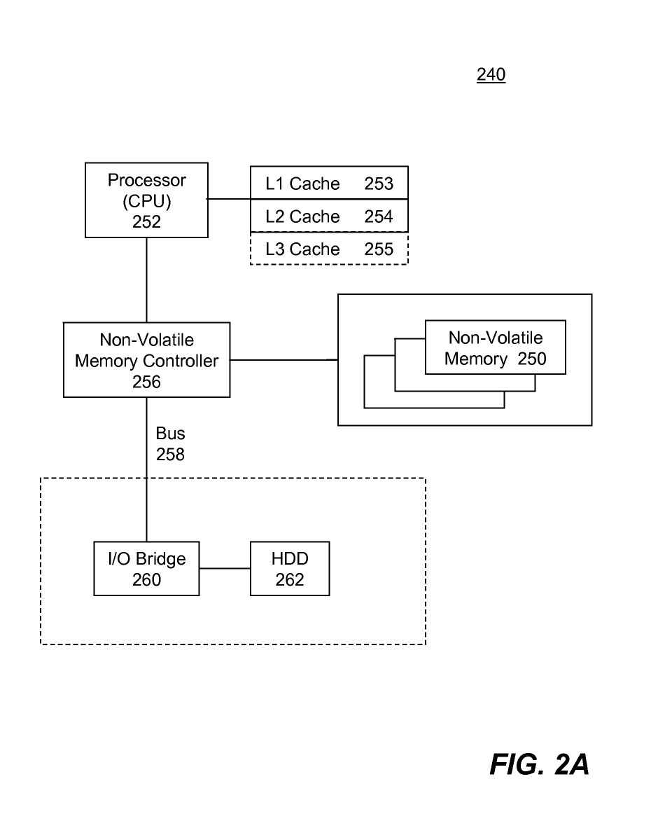

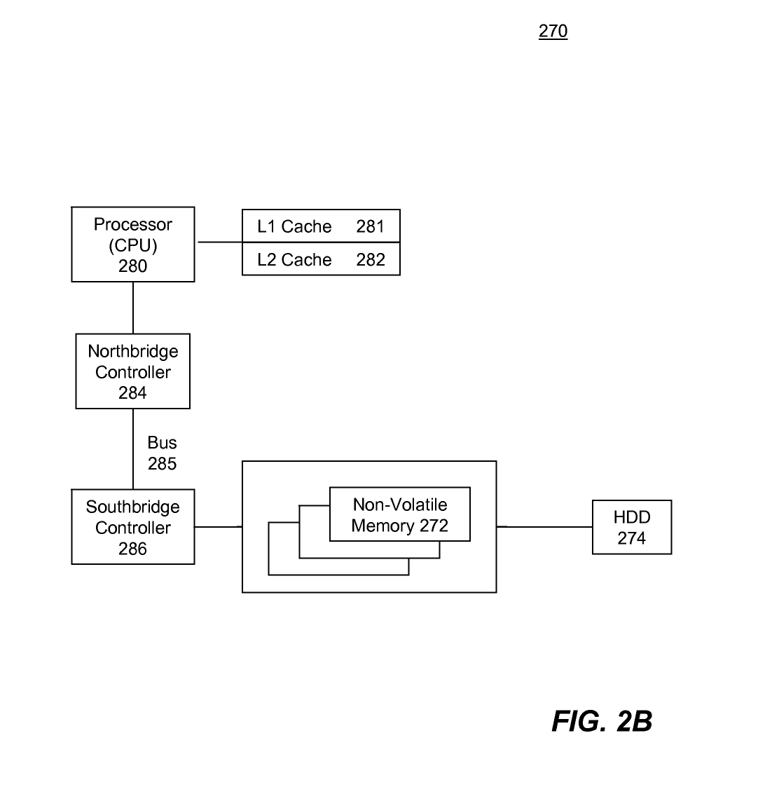

Embodiments of the present invention are discussed herein with reference to FIGS. 2A-7B. However, those skilled in the art will readily appreciate that the detailed description given herein with respect to these figures is for explanatory purposes as the invention extends beyond these limited embodiments.

Referring now to the drawings, FIG. 2A block diagram showing salient components of a first exemplary non-volatile memory based computer system 240 configured with one or more non-volatile memory modules 250 in accordance with one embodiment of the present invention. The computer system 240 comprises one or more microprocessor or processor (Central Processing Unit (CPU)) 252, a non-volatile memory controller 256, and at least one non-volatile memory modules 250. The processor 252 further includes at least one level of cache memories, for example, L1 cache (level 1 cache) 253, L2 cache (level 2 cache) 254 and optional L3 cache (level 3 cache) 255. The cache memories are generally coupled to the processor 252 tightly, for example, L1 cache 253 may be located on the processor 252, L2 cache 254 and L3 cache 255 may be located near the processor 252 via a fast data bus on mother board.

A cache memory of a CPU is configured to reduce the average time to access main memory. The cache is a smaller, faster memory which stores copies of the data from the most frequently used main memory locations. As long as most memory accesses are to cached memory locations, the average latency of memory accesses will be closer to the cache latency than to the latency of main memory. The cache memory includes a plurality of cache lines, which are sized from 32-byte to 1024-byte, for example.

Non-volatile memory such as flash memory or phase change memory is configured to be electrically erased and reprogrammed. The data structure of a non-volatile memory comprises a plurality of blocks, which is further divided into a plurality of pages. Each page may contain 512-byte to 4,096-byte of data. The multiples between block and page are generally in the power of two such that digital computer systems can manage non-volatile memory using the data structure easier since the digital computer systems using binary numbers internally.

The non-volatile memory module 250 may include at least one non-volatile memory chip, which includes at least two planes configured to accommodate parallel data transfer operations. Two planes may also be referred to as two areas with each controlled through an independent data buffer and channel by the non-volatile memory controller 256.

In order to use non-volatile memory as main memory of the computer, the page size of the non-volatile memory module 250 is configured to be the size of one of the cache lines such that the data transfer operations can be performed efficiently.

The computer system 240 further includes optional one or more hard disk drives 262 coupled to an input/output bridge 260 mounted on the internal communication bus 258. The hard disk drives 262 are optional because the non-volatile memory module 250 may be configured as main memory and as secondary storage and because data stored on the non-volatile memory module 250 remain valid after the computer is powered off.

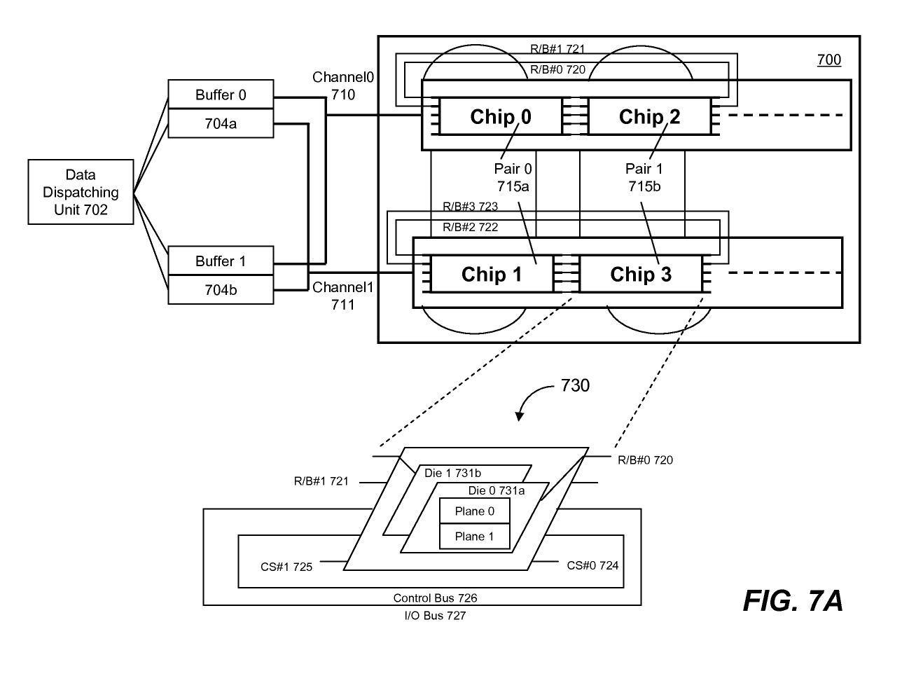

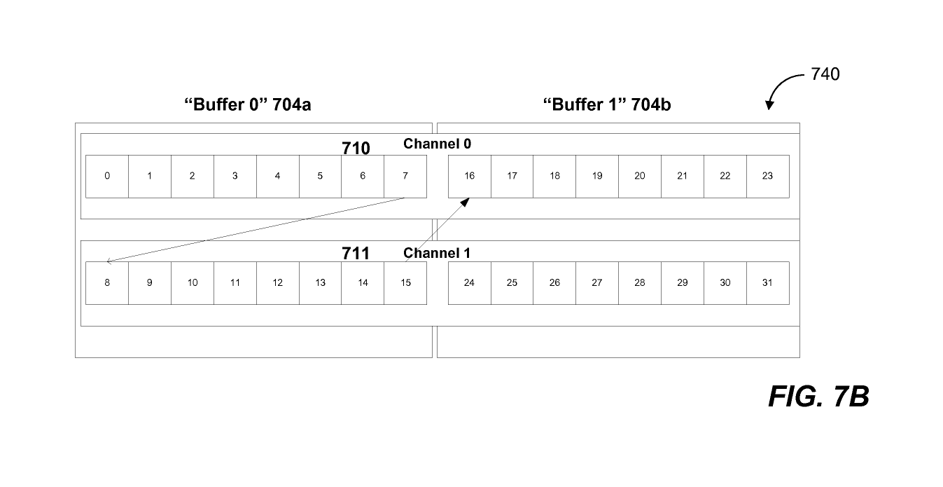

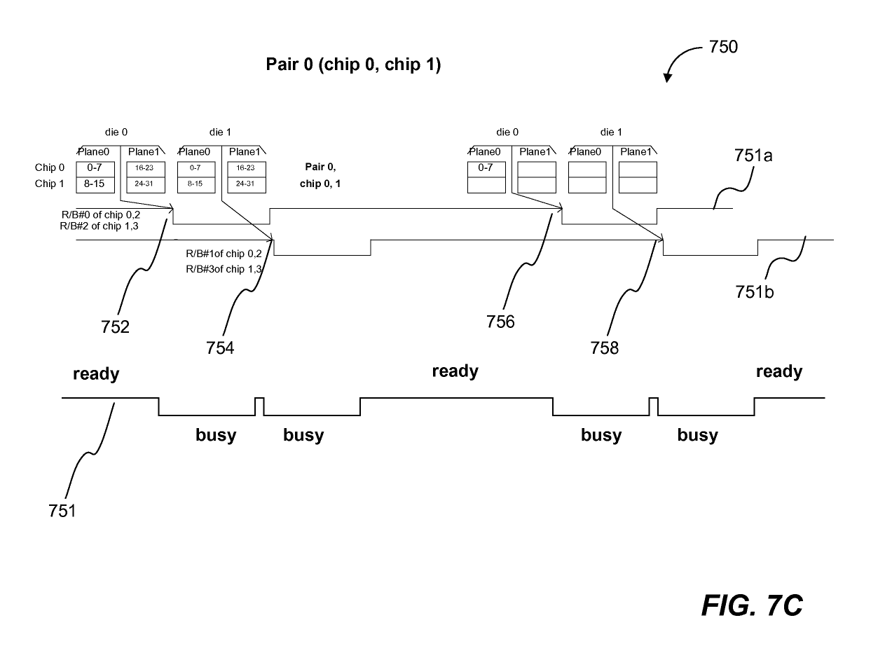

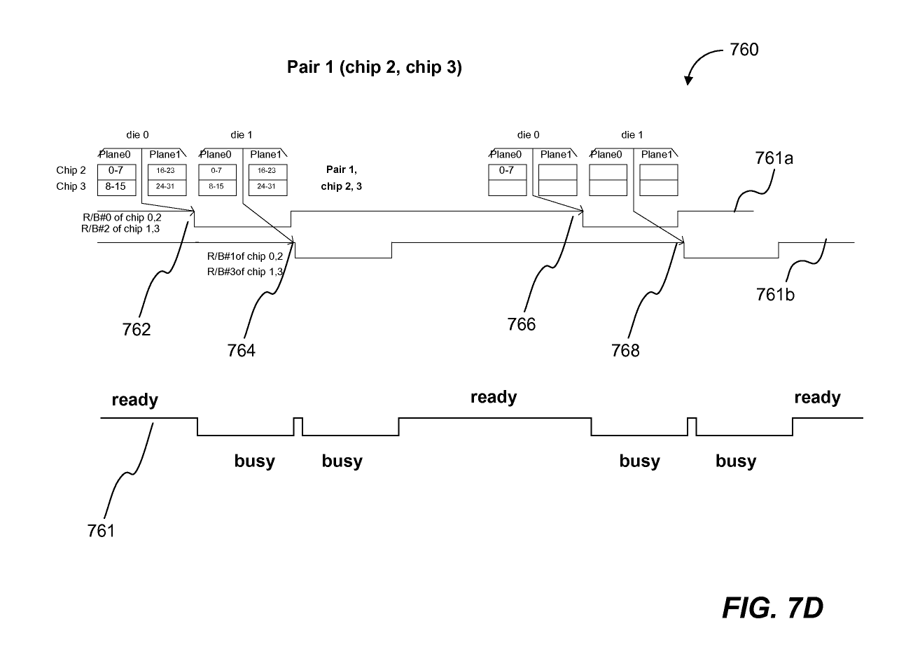

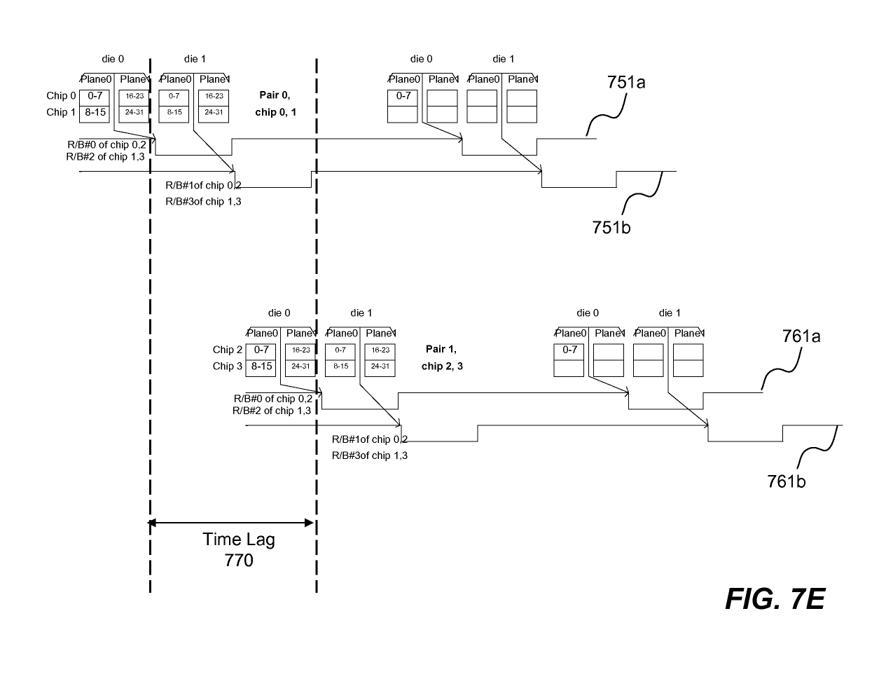

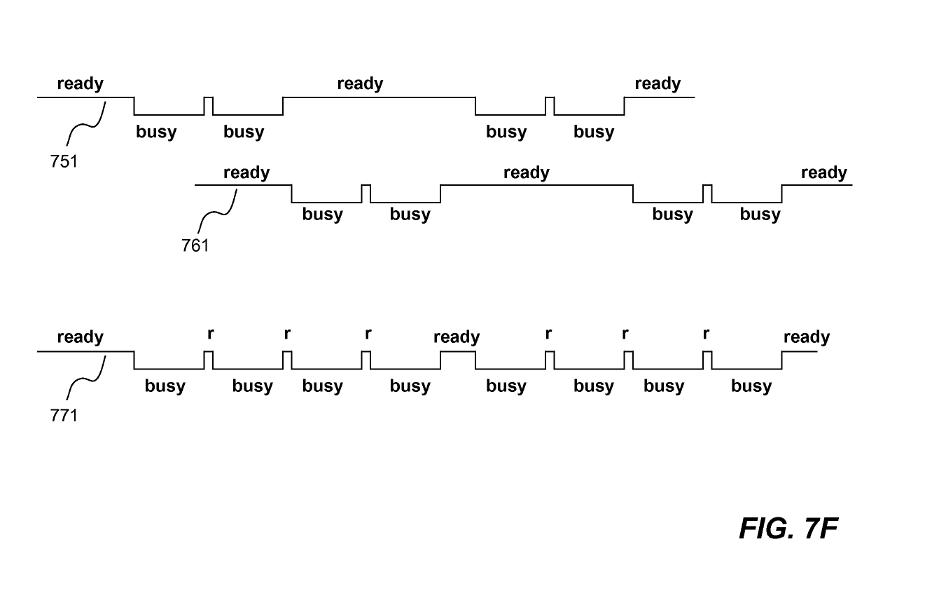

FIG. 2B shows an alternative usage of a non-volatile memory module 272 in another computer system 270, according to another embodiment of the present invention. The computer system 270 comprises at least one microprocessor or processor (CPU) 280, a northbridge controller 284, southbridge controller 286, at least one non-volatile memory module 272, and one or more hard disk drives (HDD) 274. Additionally, an internal data bus 285 is configured to provide data and control signal communications among the at least one processors 280, the northbridge controller 284, the south bridge controller 286 and the at least one non-volatile memory module 272. The at least one processor 280 includes at least one level of cache memories (e.g., L1 cache 281 and L2 cache 282). The at least one non-volatile memory module 272 is configured as data transfer (read/write) buffer for the at least one hard disk drive 274. The at least one non-volatile memory module 272 is coupled to the southbridge controller, which is configured to controls and coordinates data transfer operations to the at least one non-volatile memory module 272 and hard disk drives 274. In general, the data transfer operations may be performed independently via at least two data channels in parallel. To support such parallel data transfer operations, the southbridge controller 286 and the at least one non-volatile memory module 272 include hardware and software features. Details of these features are shown and described in FIGS. 7A-7F and the corresponding descriptions thereof.

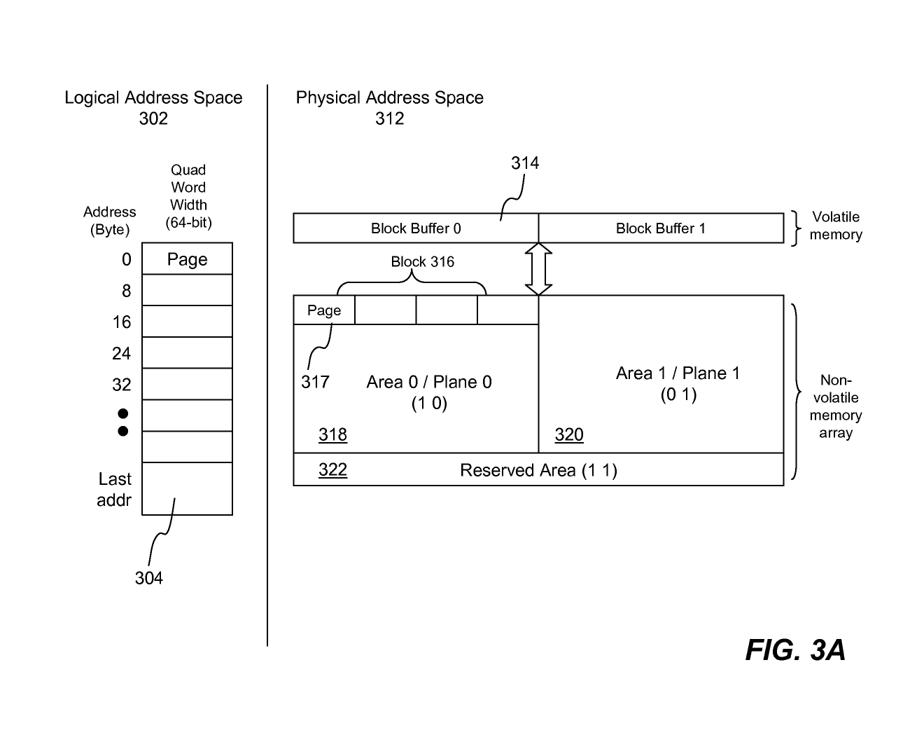

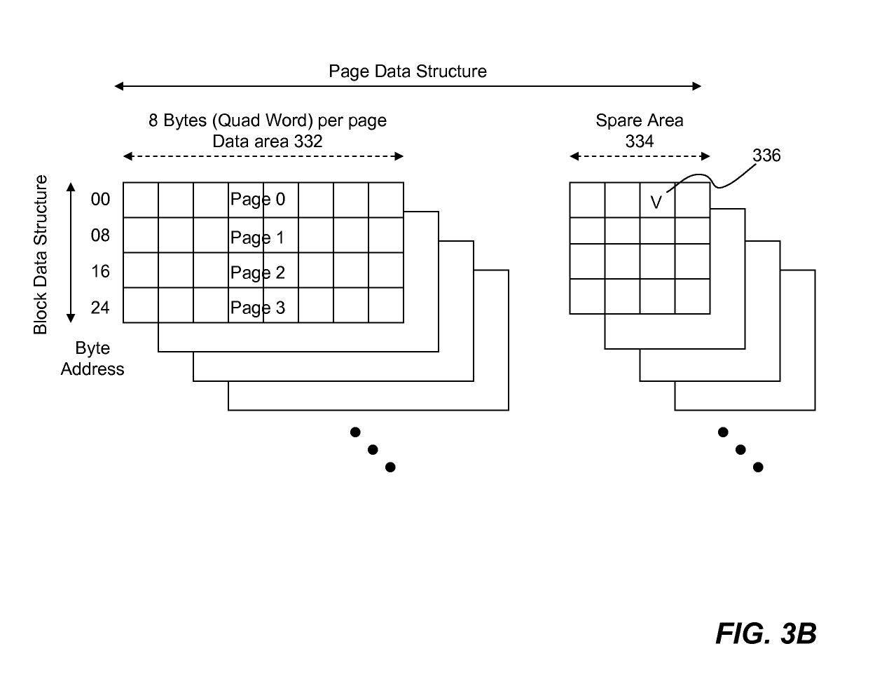

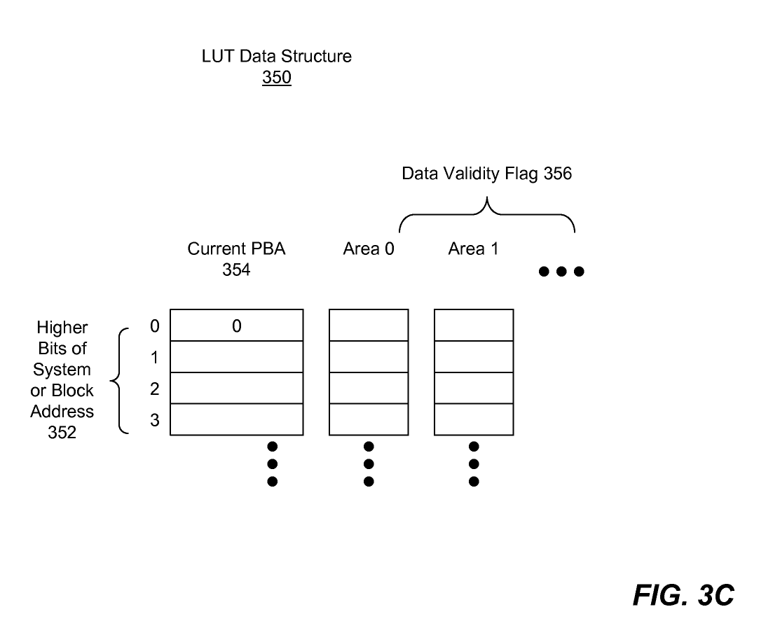

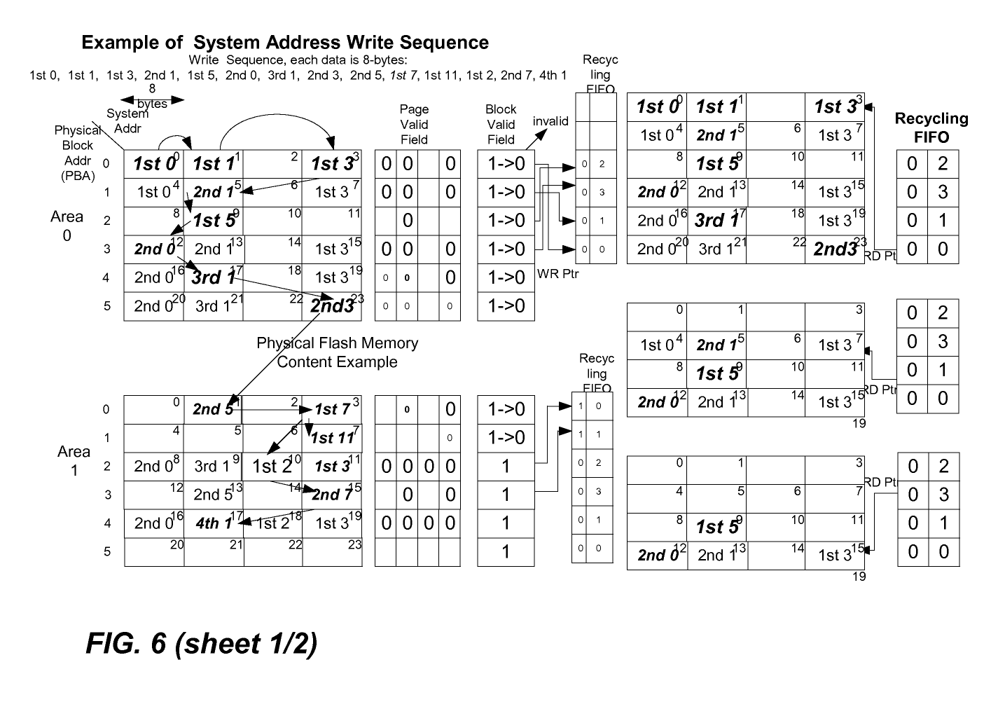

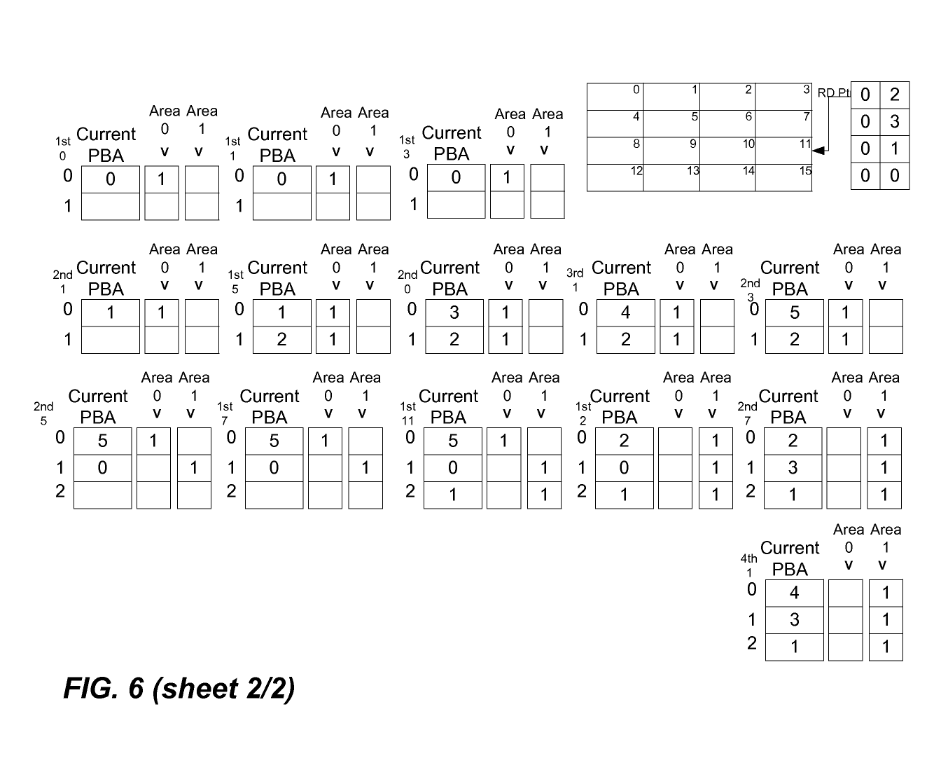

FIGS. 3A-3C are diagrams showing exemplary data structures used in the non-volatile memory controller 256 and the non-volatile memory module 250 of FIG. 2A in accordance with one embodiment of the present invention. FIG. 3A shows that an exemplary logical address space 302 comprises an address table 304 using a quad-word address (i.e., 64-bit). Each the addresses in the table 304 relates to a physical page (e.g., a cache line size for a processor or a sector size on the hard disk drive). The addresses may be in different width e.g., 128-bit or higher). The exemplary physical address space 312 shows that the non-volatile memory module 250 is divided into two main areas (i.e., “area 0/plane 0” 318 and “area 1/plane 1” 320) and a reserved area 322, each of the main areas is divided into a plurality of blocks 316, and each of the blocks is further divided into a plurality of pages 317. The size of each page is configured to be the size of a cache line, when the non-volatile memory module 250 is configured as the main memory of the computer system. The cache line is a basic unit in one of the cache memories (e.g., L1 cache 253, L2 cache 254 or L3 cache 255) associated with the microprocessor 252. A typical cache line size may have ranges from 8-byte to 512-byte. Each of the pages may be read and written in the non-volatile memory module 250 individually. However, writing over a page containing old data or dirty data is not permitted. The page must be erased or cleared before any new data can be written into. There is another limitation in non-volatile memory—erasing data can only be performed one block at a time. In other words, individual page cannot be erased. With the restrictions or limitations, data writing in non-volatile memory is complicated. A detail example is shown in FIG. 6 below. Additionally, the exemplary physical address space also includes two block buffers 314 (i.e., “block buffer 0” and “block buffer 1”) made of volatile memory generally. The block buffers 314 are configured to hold data to be swapped or replaced in the complicated data writing operations.

FIG. 3B shows a detailed data structure of block and page. In this example, each page comprises 8-byte in data area 332 and 4-byte in spare area 334. The spare area 334 includes error correction code (ECC) and a page data validity indication flag “V” 336. When the page data validity indication flag 336 may be implemented as a single-bit indicator (e.g., 0 for valid data, 1 for empty, old or dirty data). Each block contains four pages (e.g., “page 0”, “page 1”, “page 2” and “page 3”). In FIGS. 3A and 3B, numbers of main areas, reserved areas, blocks and pages are selected for an exemplary data structure. The present invention does not limit the data structure of the non-volatile memory module 250 to those numbers. For example, the number of main areas may be a much higher integer. The number of pages per block may be other power of two. The size of each page may be set differently for different usage of the non-volatile memory module.

FIG. 3C shows the data structure of an exemplary address lookup table (LUT). LUT 350 is configured to translate a logical address to a physical address. LUT 350 is generally implemented using very fast memory such as static random access memory (SRAM). If every physical address is represented in LUT 350, required SRAM would be so large thus making LUT to expensive to maintain. One method is to use only higher order bits of the address to index LUT 350. For example, truncating 6-bit of address results in a 64-fold saving of the LUT size. LUT 350 is referenced by the calculated index from a logical address whether a system memory address or a logical block address (LBA). Each of the index is associated with a current physical block address (PBA) 354 followed by a plurality of data validity flags 356, one flag for each of the main areas.

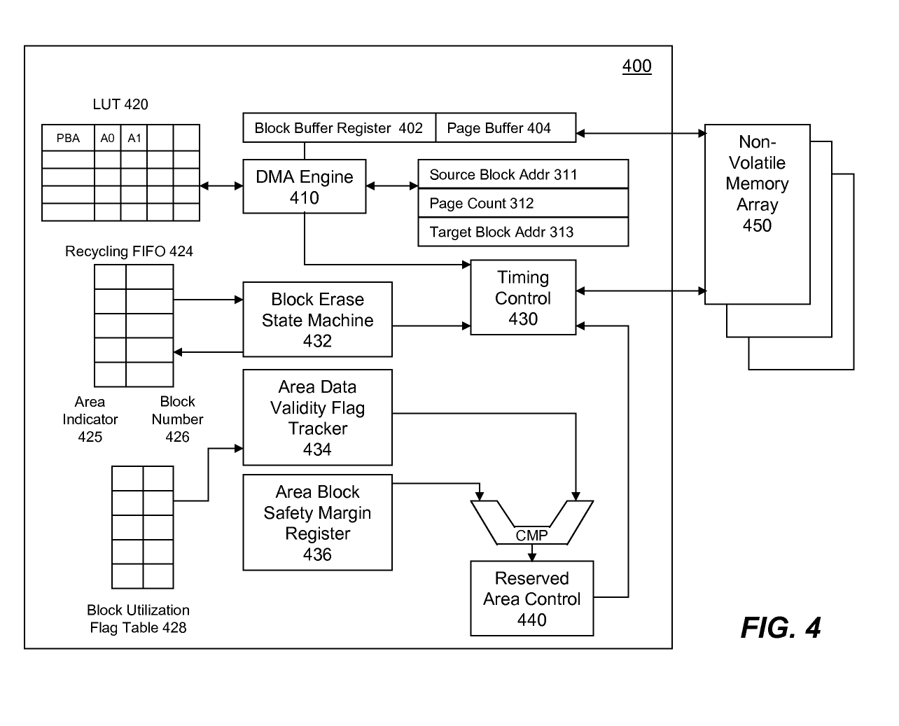

FIG. 4 is a block diagram showing salient components of an exemplary non-volatile memory controller 400 in accordance with one embodiment of the present invention. The non-volatile memory controller 400 comprises a direct memory access (DMA) engine 410, a block erase state machine 432, an area valid flag tracker 434, an area block safety margin register 436, a reserved area control 440 and a non-volatile timing control 430.

The DMA engine 410 also comprises one or more data buffers 402 and a page register 404. The one or more data buffers 402 may comprise at least one pair of parallel data buffers with each of the data buffers connected to dual data channels (see FIG. 7A below for a detailed example). The DMA engine 410 is configured to handle data transfer to and from a non-volatile memory array 450 controlled by the non-volatile memory controller 400. The DMA engine 410 further includes registers to hold vital data such as source block address 411, valid page count 412 and target block address 413. The addresses are obtained in a memory lookup table (LUT) 420.

The timing control 430 is configured to ensure data transfer properly timed, as different timing may be required for non-volatile memory manufactured by various vendors. The block erase state machine 432 is configured to track a read and write pointer to a recycling FIFO (first-in first-out) buffer 424, which includes are area indicator 425 and block number 426. The erasure of data following the order of the recycling FIFO 424. The area data validity tracker 434 is configured to manage data validity flags (e.g., flags 356 of FIG. 3C). Each block's utilization is tracked in a table 428. Because non-volatile memory has limited number of erase cycles, a technique called wear leveling is used to average out the data erasure. The area block safety margin register 436 is configured to contain a value that is safe to write or erase data. Once a block has reached a threshold (i.e., safety margin), the data block is written to the reserved area (e.g., reserved area 322 of FIG. 3A), which is performed and controlled by the reserved area control 440.

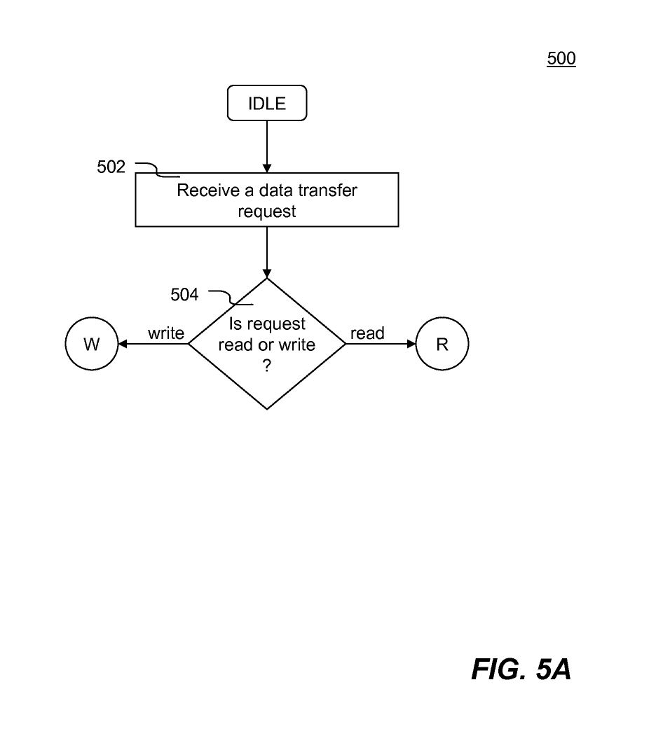

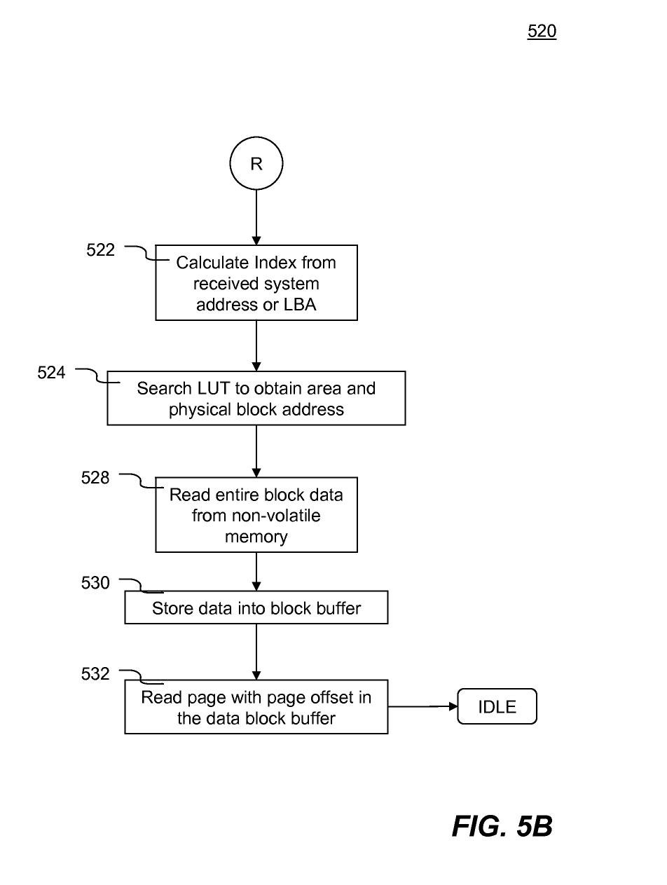

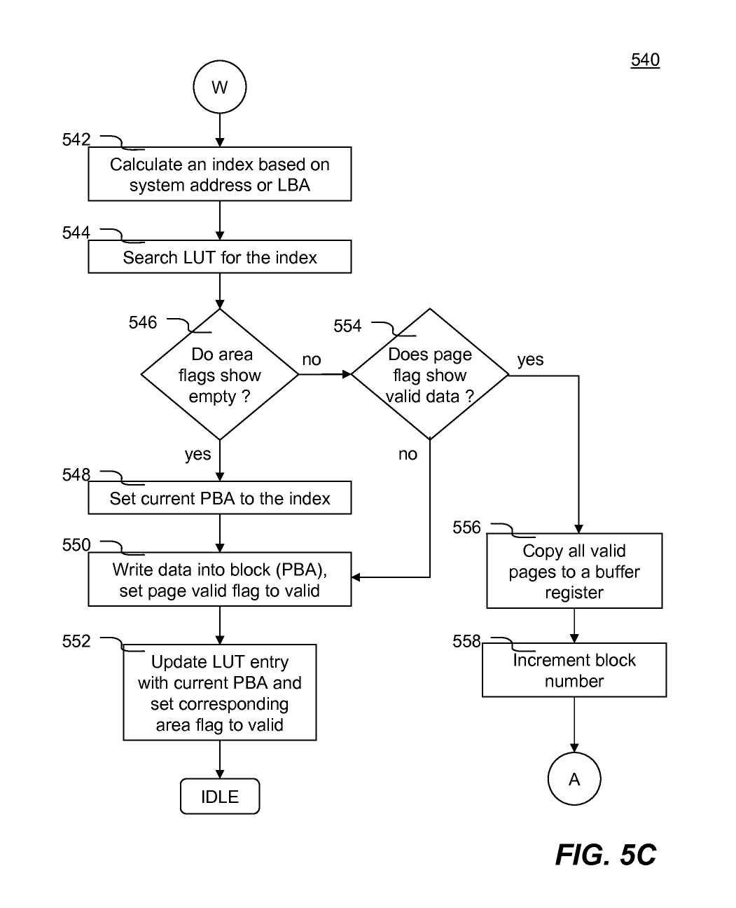

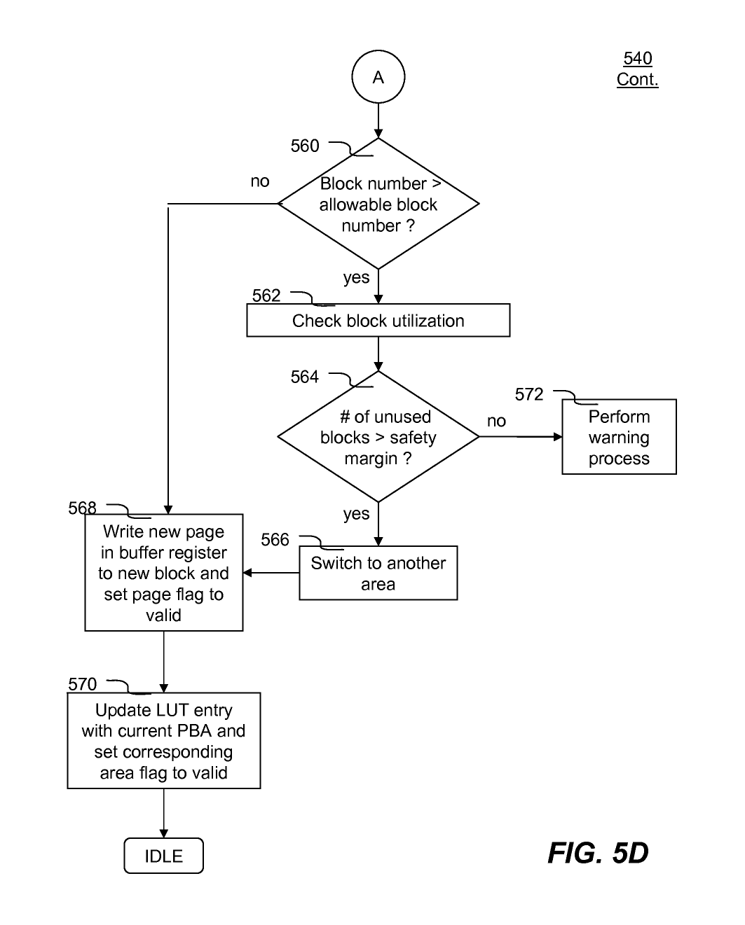

FIGS. 5A-5D are flowcharts collectively illustrating an exemplary process 500 of performing memory read/write request in the non-volatile memory controller 400 of FIG. 4, according to an embodiment of the present invention. Process 500 starts when the non-volatile memory controller (“controller” hereinafter) 400 is in an “idle” state until the controller 400 receives a data transfer request (e.g., a memory read/write request) at step 502. Next, at decision 504, the controller 400 determines whether the data transfer request is a read or write request. If the request is a “read”, the process 500 moves to R (FIG. 5B). Otherwise, the process 500 moves to W (FIGS. 5C and 5D).

The exemplary data or memory read process 520 is shown in the flowchart shown in FIG. 5B. The controller 400 calculates an index by truncating a predetermined number of bits of the received address (e.g., system memory address or LBA) at step 522. The calculation may be performed with a division or shifting operation. Next, at step 524, the calculated index is used for searching LUT to obtain a physical block address (PBA) and associated area data validity flags. Data at the PBA are read at step 528 and store into a corresponding block buffer at step 530 (e.g., block in “area 1” would be stored in “block buffer 1”). Then, at step 532, data for a desired page is read from the block buffer using a page offset, which is a remainder when calculating the index in step 522. Finally, the controller 400 returns to the “idle” state waiting for anther data transfer request.

FIGS. 5C and 5D collectively show a flowchart of an exemplary data or memory write process 540. The controller 400 calculates an index from the received address (e.g., system memory address or LBA) at step 542. Next, at step 544, the index is used in LUT to obtain a PBA and associated area data validity flags. Next, at decision 546, it is determined whether all of main areas are empty (i.e., available for writing). If “yes”, the controller 400 sets the current PBA to the index at step 548, and writes data into the block pointed by PBA with a page offset (i.e., remainder from the index calculation at step 542) and sets page data validity flag in the spare area of the page (see FIG. 3B) at step 550. Then the controller 400 updates LUT entry using the current PBA and sets the corresponding area data validity flag to valid at 552 before going back to the “idle” state for anther request.

If “no” is the result of decision 546, the controller 400 moves to another decision 554. The page validity flag for the particular page is checked. If there is no valid date (i.e., empty), then the controller 400 performs steps 550 and 552 before going back to the “idle” state. Otherwise, if the particular page contains valid data, the result of decision 554 is “yes”, then the controller 400 moves to step 556 to copy all valid pages in this block to a buffer register. Next, the controller 400 increments block number base on a set of predefined rules (e.g., increment the block number by one) at step 558. Then the controller 400 checks the newly incremented block number against the allowable block number at decision 560. If the new block number is less than the allowable, the controller 400 following the “no” path to step 568. The controller 400 writes a new page into the buffer register using a page offset. The buffer register contains all other valid pages from step 556. The update buffer register is then copied into the new block (i.e., newly incremented block number). And the controller 400 sets the page data validity flag to valid and sets the old block to invalid or dirty (i.e., to be erased) in a recycling FIFO (see FIG. 4). At step 570, the controller 400 updates LUT with current PBA and sets the corresponding area data validity flag to valid before going back to the “idle” state.

Referring back to decision 560, if “yes” or the new block number is greater than the allowable, the controller 400 checks the block utilization at step 562. Next, at decision 564, it is determined whether number of free or unused blocks is greater than a predefine safety margin. If “yes”, the controller 400 switches to another area at step 566 and performs step 568 and 570 before backing to “idle”. Otherwise a warning process is embarked at step 570 as the number of the unused blocks is too low. In other words, house keeping functions such as erasing additional invalid or dirty blocks may be required. When the process 540 increments a block number or switches to another area, the physical address obtained from LUT has been altered. The altered physical address is referred to as a second physical address, while the original physical address is referred to as a first physical address in this document. The second physical address is derived from the first physical address. The first and the second physical address share a same page offset and have a different area or block number.

FIG. 6 is a schematic diagram showing an example of writing data into a non-volatile memory module (e.g., non-volatile memory module 250 of FIG. 2A) in accordance with one embodiment of the present invention. The example is to write a series of 8-byte data into a non-volatile memory module in the following order: 1^{st} page 0, 1^{st} page 1, 1^{st} page 3, 2^{nd} page 1, 1^{st} page 5, 2^{nd page} 0, 3^{rd} page 1, 2^{nd} page 3, 2^{nd} page 5, 1^{st} page 7, 1^{st} page 11, 1^{st} page 2, 2^{nd} page 7 and 4^{th} page 1. Order index, 1^{st}, 2^{nd}, 3^{rd}, represent number of times writing to the followed page number.

For demonstration purpose, assumptions in this example is that the set of predefined rules is to increment block number by one first. Once the total number of blocks has reached in “area 0”, the next block increment would go to “area 1” in a sequential order in this example. Four pages per block, five blocks per area and total of two main areas. The present invention sets no limit as to these numbers.

Solid arrowed lines show the order of these data write is performed. For example, 1^{st} page 0, 1^{st} page 1 and 1^{st} page 3 are written to “block 0”. When 2^{nd} page 1 needs to be written, the page data validity flag would show a valid data in page 1, therefore 2^{nd} page 1 needs to be written to “block 1” (i.e., “block 0” is incremented by 1). In the mean time, all other valid pages (i.e., page 0 and page 3 in “block 0”) must be copied to “block 1” through a block register (see steps 558, 560, 568 and 570 of FIGS. 5C and 5D). Once all of the valid pages in “block 0” is copied to “block 1”, “block 0” is marked as invalid (1->0) in FIG. 6. Once the entire block contains invalid data, a read pointer is logged into the recycling FIFO buffer (e.g., (0,0) indicates area 0, block 0). In other words, “block 0” is slated to be erased if necessary.

The rest of data write operations follows the same set of rules. For example, 1^{st} page 5 is written to “block 2” because “block 0” is marked with invalid at this point. “block 0” will be available after the entire block has been erased. In order to average out the usage (i.e., wear leveling), “block 0” will not be reused right away if an “invalid” or “dirty” flag is set. Block erasure and reuse would occur when all of the available blocks within a predefined safety margin or threshold have been used once. Furthermore, in the example, LUT is shown after each data write. It is evident the physical block address is entered in LUT along with corresponding area data validity flags (i.e., step 552 of FIG. 5C or step 570 of FIG. 5D).

FIGS. 7A-7F are schematic diagrams collectively showing exemplary parallel interleaved data transfer operations of a non-volatile memory based computer system, according to an embodiment of the present invention. A data dispatching unit 702 (e.g., a non-volatile memory controller, an I/O controller, etc.) is configured to read and write data to a non-volatile memory module 700 using dual data channels (i.e., “channel 0” 710 and “channel 1” 711) with a pair of parallel data buffers (i.e., “buffer 0” 704a and “buffer 1” 704b). Connection between the data buffers and the data channels shown in FIG. 7A is referred to as connected in an interleaved manner. The non-volatile memory module 700 comprises at least one non-volatile memory chip or integrated circuit. However, in order to achieve optimal performance or rate of data transfer, at least four chips (i.e., “chip 0”, “chip 1”, “chip 2” and “chip 3”) are required in this example. The chips are grouped as “pair 0” 715a consisting “chip 0” and “chip 1”, and “pair 1” 715b consisting “chip 2” and “chip 3”.

Each of the pair of data buffers 704a and 704b is partitioned into two entries. Each entry's size matches the page size of the non-volatile memory module 700. The page size may be set to 4096-byte for a secondary storage application or 512-byte for a main memory application. Each of the entries within one data buffer (e.g., “buffer 0”) connects to an independent data channel. For example, “channel 0” 710 connects to first entry of both “buffer 0” 704a and “buffer 1” 704b, while “channel 1” 711 connects to second entry. The non-volatile memory chips are connected in the following order: “chip 0” and “chip 2” with “channel 0” 710, and “chip 1” and “chip 3” with “channel 1” 711. In other words, the read busy signal pins of “chip 0” and “chip 2” are connected together as “R/B#0” 720 and “R/B#1” 721. Similarly, “R/B#2” 722 and “R/B#3” 723 are for “chip 1” and “chip 2”. An exploded view 730 shows more details of each of the non-volatile memory chip. In this embodiment, the chip comprises two identical dies (i.e., “die 0” 731a and “die 1” 731b connected together. There are two planes (i.e., “plane 0” and “plane 1”) on each die. Main areas of the non-volatile memory module described in FIG. 3A may be implemented using “plane 0” and “plane 1”. Other pins on the chip include control bus 726, I/O bus 727 and independently selected “chip select” (i.e., “CS#0” 724 and “CS#1” 725).

FIG. 7B shows a detail diagram 740 of parallel data buffers. “buffer 0” 704a and “buffer 1” 704b are identical. Each is connected to both “channel 0” 710 and “channel 1” 711. Each of the data buffers contains two entries. The entry for “buffer 0” and “channel 0” includes data chunks “0”, “1”, “2”, “3”, “4”, “5”, “6” and “7” (denoted as “0-7” for FIGS. 7C-7F). The data chunks may be sectors or words that are smaller then a page. Using similar technique, each of the other entries is denoted by the following labels: “8-15” for “buffer 0” and “channel 1”, “16-23” for “buffer 1” and “channel 0”, and “24-31” for “buffer 1” and “channel 1”. In order to ensure the data transfer operations performed in parallel, contiguous data need to be stored in the manner described herein such that the interleaved connected data buffers and data channels can perform data transfer operations in parallel independently.

FIGS. 7C-7F collectively show ready/busy signals of the exemplary dual-channel data transfer using parallel data buffers in the interleaved scheme in accordance with one embodiment of the present invention. A schematic diagram 750, shown in FIG. 7C, is a read/busy signal timing line for “pair 0” 715a (i.e., “chip 0” and “chip 1”) defined in FIG. 7A. The timing line starts when parallel data buffers (e.g., “buffer 0” 704a and “buffer 1” 704b are both filled with data to be transferred. A first ready/busy signal line 751a for “R/B #0” shows a dip (i.e., busy) at time 752. Once the data have started transferred to the non-volatile memory module, “buffer 0” 704a and “buffer 1” 704b are filled with new data to be transferred. A second read/busy signal timing line 751b shows another dip at time 754. The same process repeats after the data have been transferred to the non-volatile memory. A second set of dips at time 756 and time 758 are marked in the respective timing lines 751a and 751b. The process goes on for “pair 0” repeating again and again. It is noted that the first and second timing lines 751a and 751b are shown for clarity to understand the process. The ready/busy timing line should be just one line. In other words, the first and second ready/busy timing lines 751a and 751b should be combined to a “pair 0” timing line 751. “ready and “busy” states are shown in the “pair 0” timing line 751. For “pair 1” 715b (i.e., “chip 2” and “chip 3”), a “pair 1” timing line 761 is shown in FIG. 7D similarly.

Since “pair 0” and “pair 1” are independently connected, the “pair 0” timing line 751 and the “pair 1” timing line are in reality offset by a time lag 770. FIG. 7E shows a relative position of the “pair 0” timing line 751 of FIG. 7C and the “pair 1” timing line 761 of FIG. 7D. A combine timing line is referred to as a ready/busy timing line 771 shown in FIG. 7F, which shows the entire line is almost in “busy” state. The “ready” or “r” states as shown occupy very small portion of the timing line 771. Therefore, the data transfer is performed in a high efficiency. In another embodiment, the timing line 771 may be in a constant “busy” state.

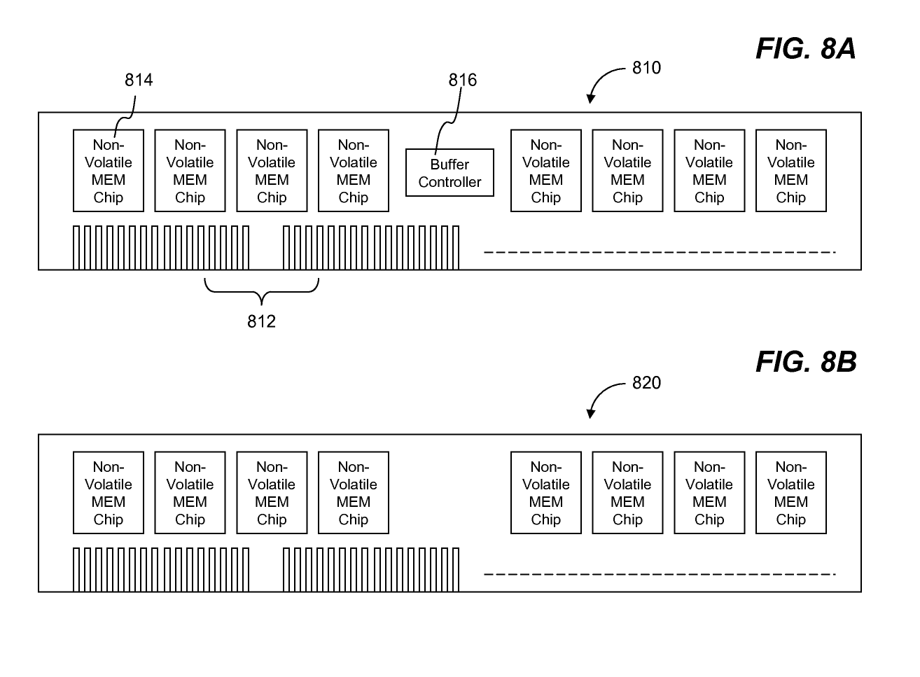

FIGS. 8A and 8B illustrate first and second exemplary non-volatile memory modules according an embodiment of the present invention. The module 810 comprises a plurality of non-volatile memory chips 814 mounted on a board (e.g., printed circuit board) and a buffer controller 816 (e.g., non-volatile memory controller 400 of FIG. 4) also mounted thereon. A set of standard connectors 812 are operative to connect to a mother board of a computer system 240 of FIG. 2A. Each of the non-volatile memory chips 814 may include multiple dies and each of the dies may contain multiple planes. FIG. 8B shows an alternative module 820 without a controller. All of the controls are handled by a controller located on the host computer system.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas areas, blocks and pages of a non-volatile memory module are shown and described with certain numbers, other combination may be used. Additionally, whereas data buffers and data channels are shown and described as dual-channel connecting to a pair of parallel data buffers to perform interleaved data transfer operations, other higher numbers of data buffers and channels (e.g., four, eight or higher) may be used to accomplish a better efficiency. In summary, the scope of the invention should not be restricted to the specific exemplary embodiments disclosed herein, and all modifications that are readily suggested to those of ordinary skill in the art should be included within the spirit and purview of this application and scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A non-volatile memory based computer system comprising:
an internal communication bus;
at least one input/output (I/O) interface coupling to an I/O controller via said internal communication bus;
at least one microprocessor configured to include at least one cache memory, each of the at least one cache memory includes a plurality of cache lines;
at least one non-volatile memory module; and
a non-volatile memory controller coupling to said at least one processor and said at least one non-volatile memory module via said internal communication bus, said at least one non-volatile memory module is divided to a plurality of addressable areas and a separate reserved area, each of the addressable areas and the reserved area is partitioned to a plurality of blocks and each block is partitioned to a plurality of pages.

22. The computer system of claim 21 further comprises one or more hard disk drives coupling to an I/O bridge through the I/O controller.

23. The computer system of claim 22, wherein each of said at least one non-volatile memory module includes at least one flash memory integrated circuit or chip.

24. The computer system of claim 23, wherein each of the at least one flash memory chip comprises at least two independent data buffers connected to at least two data channels configured for parallel data transfer operations.

25. The computer system of claim 24, wherein said at least two data channels are connected to the at least two data buffers.

26. The computer system of claim 25, wherein said at least to data buffers are arranged in an interleaved manner with respect to said at least two data channels.

27. The computer system of claim 25, wherein said non-volatile memory module comprises at least four non-volatile memory chips to enable the parallel data transfer operations, each of the chips includes two connected dies with two planes for said each chip.

28. The computer system of claim 27, each of the dies is configured to be individually selected.

29. The computer system of claim 28, said each of the dies is further includes a ready/busy signal line.

30. The computer system of claim 21, wherein the plurality of addressable areas is configured to store data in an interleaved manner.

31. The computer system of claim 30, wherein each of the plurality of addressable areas is configured to have an independent block buffer made of volatile memory.

32. The computer system of claim 21, wherein said non-volatile memory controller is further configured to control data operations for memory read, write and erasure.

33. The computer system of claim 32, wherein the memory read or write request comprises reading from or writing into a particular one of the plurality of pages, respectively.

34. The computer system of claim 32, wherein the memory erasure request comprises erasing a specific one of the plurality of blocks in its entirety.

35. The computer system of claim 21, said separate reserved area is configured to provide additional data storage when the plurality of addressable areas has run out of empty space.

36. The computer system of claim 21, said cache memory comprises dynamic random access memory.

37. The computer system of claim 21, wherein the page's size is configured to be one or more multiples of the cache line's size.
